(19) United States
(12) Patent Application Publication
(10) Pub. No.: US 2025/0289632 A1
(43) Pub. Date: Sep. 18, 2025

(54) MAGNETIC CONNECTING ATTACHMENT, LID ASSEMBLY, AND CONTAINER ASSEMBLY FOR BEVERAGES OR FOOD

(71) Applicant: EVOLUTIVE LABS CO., LTD., Taipei City (TW)

(72) Inventors: Jui-Chen LU, Taichung City (TW); Cheng-Che HO, Taichung City (TW)

(73) Assignee: EVOLUTIVE LABS CO., LTD., Taipei City (TW)

(21) Appl. No.: 19/077,012

(22) Filed: Mar. 11, 2025

Related U.S. Application Data
(60) Provisional application No. 63/565,524, filed on Mar. 14, 2024.

(51) Int. Cl. B65D 51/24; B65D 55/00; F16M 13/02

(52) U.S. Cl. CPC B65D 51/24; B65D 55/00; F16M 13/022

(57) ABSTRACT

A magnetic connecting attachment adapted for a lid with an engaging feature and a mobile device is provided. The magnetic connecting attachment includes a main body and a magnetic connecting member. The main body is formed with an engaging slot and adapted to define a passage. The engaging slot is selectively engaged with the engaging feature, and the main body sleeves is adapted to sleeve the lid through the passage. The magnetic connecting member is pivotally or detachably connected to the main body and adapted to be magnetically connected to the mobile device. Besides, a lid assembly and a container assembly for beverages or food respectively include the magnetic connecting attachment are also provided.

### CROSS-REFERENCE TO RELATED APPLICATION

This non-provisional application claims priority under 35 U.S.C. § 119(e) on U.S. provisional Patent Application No(s). 63/565,524 filed on Mar. 14, 2024, the entire contents of which are hereby incorporated by reference.

### BACKGROUND OF THE INVENTION

### 1. Field of the Invention

The present disclosure provides a magnetic connecting attachment, a lid assembly, and a container assembly for beverages or food, and in particular, relates to a magnetic connecting attachment, a lid assembly, and a container assembly for beverages or food that can magnetically connect a mobile device to a specific position.

### 2. Description of the Related Art

With the development of science and technologies, people use mobile devices such as a smartphone, a smart watch, and a tablet computer more and more. In addition, with the popularity of social software such as INSTAGRAM, TIKTOK, and LASSO, many people are devoted to photographing short films with personal styles and uploading the short films to social platforms, to share the short films with friends or netizens in real time. Therefore, online audio and video gradually replace conventional television programs, and become one of mainstream media.

Fitness enthusiasts serve as an example. When exercising in a gym, the fitness enthusiasts often need to watch instructional videos on the internet, or record body movements in a training process, to facilitate posture adjustments or repetitions. However, because a user needs to move regularly, or holds training equipment such as a dumbbell, a barbell, or an equipment handle for a long time with both hands, it is inconvenient to maintain the mobile device at a specific position in a handheld manner. Therefore, some users can only place the mobile devices on fitness equipment, or purchase mobile phone holders with tripods or wall-mounting accessories to fix the mobile devices. In this way, in addition to basic sports goods such as a water bottle and a towel, the users need to additionally carry a dedicated accessory to fix an electronic device, which causes inconvenience in use.

### BRIEF SUMMARY OF THE INVENTION

In addition, due to the need for drinking water or taking food, some users may purchase a container such as a water bottle or a thermos, and use the container with a mobile device at the same time. However, whether for facilitating the user to lift the container or improving a visual feature of the container, the container may have a protruding structure relative to the entire bottle. Therefore, if these containers could be equipped with a function to fix the mobile device, it would make these containers more convenient to use.

The inventor devoted all efforts to researching and developing a magnetic connecting attachment, a lid assembly, and a container assembly for beverages or food that can magnetically connect the mobile device to a specific position, to free up both hands for using the mobile device or other items.

The present disclosure provides a magnetic connecting attachment, adapted for a lid and a mobile device, and the lid includes an engaging feature. The magnetic connecting attachment includes a main body and a magnetic connecting member. The main body is formed with an engaging slot, the main body is adapted to be arranged on the lid, and the engaging slot is adapted to be engaged with the engaging feature. The magnetic connecting member is adapted to be magnetically connected to the mobile device, and may be pivotally or detachably connected to the main body.

In an implementation, the main body defines a passage, and the main body is adapted to sleeve the lid through the passage.

In an implementation, the passage extends along a longitudinal direction. The main body includes a top portion, the engaging slot is formed on the top portion and extends along the longitudinal direction, and the magnetic connecting member is pivotally or detachably configured on the top portion.

In an implementation, the main body further includes an engaging portion, and the engaging portion protrudes inward the engaging slot.

In an implementation, the magnetic connecting attachment further includes a fastening member, and the fastening member is detachably connected to the main body and selectively engaged with the engaging slot.

In an implementation, the fastening member includes a cover portion and a fastening portion. The cover portion includes an upper cover portion and a lower cover portion, and an outer diameter of the upper cover portion is substantially the same as an outer diameter of the main body. The lower cover portion is connected to the upper cover portion, and an outer diameter of the lower cover portion is substantially the same as an outer diameter of the passage. The fastening portion is connected to the upper cover portion and adjacent to the lower cover portion, a shape of a part of the fastening portion corresponds to a slot wall of the engaging slot, and a shape of another part of the fastening portion corresponds to the engaging feature.

In an implementation, the upper cover portion is formed with an upper cover accommodating portion.

In an implementation, the magnetic connecting member includes a lock portion, the main body is formed with a positioning slot, and the lock portion is selectively embedded in the positioning slot.

In an implementation, the magnetic connecting attachment further includes a lifting member, and two ends of the lifting member are respectively connected to two sides of the main body.

In an implementation, the connection piece further includes a connection portion, and the connection portion is connected to the main body and is formed with a hole.

In an implementation, the magnetic connecting attachment further includes a holding member, and the holding member is configured on an inner peripheral wall of the main body. A size of the passage is slightly larger than a size of the lid, and at least one part of the holding member protrudes inward the passage.

In an implementation, the inner peripheral wall is formed with an avoidance slot, and another part of the holding member is accommodated in the avoidance slot.

In an implementation, the main body is adapted to be deformed and includes a first end and a second end, and the first end and the second end are detachably connected to each other. When the first end abuts against the second end, the main body surrounds to form the passage.

In an implementation, the passage extends along a longitudinal direction, the main body includes a top portion and a bottom portion, the magnetic connecting member is pivotally or detachably configured on the top portion, and the engaging slot extends along the longitudinal direction to form an opening at the bottom portion.

In an implementation, the magnetic connecting attachment further includes a fastening member, the fastening member includes an annular body and is provided with a second combination portion, the bottom portion of the main body is provided with a first combination portion, the fastening member is detachably connected to the first combination portion of the main body through the second combination portion, the engaging feature of the lid abuts against an upper slot wall of the engaging slot, a limiting portion of the lid passes through the engaging slot, and the annular body abuts against the limiting portion.

In an implementation, the first combination portion of the main body and the second combination portion of the fastening member are in an internal thread structure and an external thread structure that can be screwed with each other.

In an implementation, the first combination portion of the main body is at least one bump, the second combination portion of the fastening member is at least one L-shaped slot arranged on the annular body, a guide block is configured in the L-shaped slot, the fastening member is positioned and sleeved in the bump of the main body through the L-shaped slot, and when the fastening member rotates relative to the main body, the bump follows guidance of the guide block to tighten the fastening member toward the main body.

In an implementation, the magnetic connecting member has a magnetic attraction portion and a cover, the magnetic attraction portion has a third combination portion, the cover has a fourth combination portion, the cover is fitted to the third combination portion of the magnetic attraction portion through the fourth combination portion, and a magnetic slot is formed inside the magnetic attraction portion and the cover for accommodating a magnet.

In an implementation, the third combination portion of the magnetic attraction portion and the fourth combination portion of the cover are in an internal thread structure and an external thread structure that are screwed with each other, each of the magnetic attraction portion and the cover is provided with a pin hole, the pin hole provided on the magnetic attraction portion runs through the third combination portion, the pin hole provided on the cover runs through the fourth combination portion, and when the cover is fitted to the magnetic attraction portion, the pin hole of the cover is aligned with the pin hole of the magnetic attraction portion for inserting a positioning pin.

In an implementation, the magnetic connecting member includes at least one leak-proof ring, to enable the leak-proof ring to seal the magnetic slot.

In an implementation, a quantity of leak-proof rings may be two, the cover has an inner annular wall, when the cover is fitted to the magnetic attraction portion, the inner annular wall abuts against an inner peripheral surface of the magnetic attraction portion, the cover has an annular boss for the magnet to be placed and arranged, at least one stopper is connected to the annular boss, one leak-proof ring is arranged between the annular boss and the inner annular wall, and the other leak-proof ring is arranged at an outer periphery of the annular boss and is partially blocked below the stopper.

In an implementation, the magnetic connecting attachment further includes a pivoting base, the pivoting base is fixedly connected to the main body, the magnetic connecting member includes a pivoting portion and two positioning plugs, the pivoting base passes through a recessed portion formed by the pivoting portion, the two positioning plugs are arranged in the pivoting portion, each of the two positioning plugs is provided with a pin hole, the pivoting portion is provided with two pin holes to respectively correspond to the pin holes of the two positioning plugs, and the two pin holes are for inserting a positioning pin respectively.

In addition, the present disclosure further provides a lid assembly, adapted for a mobile device. The lid assembly includes a lid and a magnetic connecting attachment, the lid includes an engaging feature, and the magnetic connecting attachment includes a main body and a magnetic connecting member. The main body is formed with an engaging slot, the main body is arranged on the lid, and the engaging slot is engaged with the engaging feature. The magnetic connecting member may be pivotally or detachably connected to the main body, and is adapted to be magnetically connected to the mobile device.

In an implementation, the lid further includes a limiting portion, the limiting portion is configured on the engaging feature, a size of the engaging feature is substantially the same as a size of at least one part of the engaging slot, and a size of the limiting portion is larger than a size of the at least one part of the engaging slot.

In an implementation, the main body defines a passage, and the main body is adapted to sleeve the lid through the passage.

In an implementation, the passage extends along a longitudinal direction, the main body includes a top portion and a bottom portion, the magnetic connecting member is pivotally or detachably configured on the top portion, and the engaging slot extends along the longitudinal direction to form an opening at the bottom portion.

In an implementation, the magnetic connecting attachment further includes a fastening member, the fastening member includes an annular body and is provided with a second combination portion, the bottom portion of the main body is provided with a first combination portion, the fastening member is detachably connected to the first combination portion of the main body through the second combination portion, the engaging feature of the lid abuts against an upper slot wall of the engaging slot, a limiting portion of the lid passes through the engaging slot, and the annular body abuts against the limiting portion.

In addition, the present disclosure further provides a container assembly for beverages or food, adapted for a mobile device. The container assembly for beverages or food includes a body portion, a lid, and a magnetic connecting attachment. The lid is configured on the body portion and includes an engaging feature, and the magnetic connecting attachment includes a main body and a magnetic connecting member. The main body is formed with an engaging slot, the main body is adapted to be arranged on the lid, and the engaging slot is engaged with the engaging feature. The magnetic connecting member may be pivotally or detachably connected to the main body, and is adapted to be magnetically connected to the mobile device.

In an implementation, the main body defines a passage, and the main body is adapted to sleeve the lid through the passage.

Therefore, the magnetic connecting attachment in the present disclosure may be sleeved on the lid through the main body, and is fitted to the lid through an engaging relationship between the engaging feature and the engaging slot. In addition, the magnetic connecting member may pivot or move relative to the main body while being magnetically connected to the mobile device, and the mobile device is fixed, relative to the lid, to a position suitable for a user to operate or view, thereby freeing up both hands of the user to use the mobile device or other items. In addition, the lid assembly and the container assembly for beverages or food in the present disclosure include the foregoing magnetic connecting attachment. Therefore, the same effect can also be achieved, thereby improving use convenience.

To make the foregoing features and advantages of the present disclosure more obvious and understandable, the embodiments are described in detail below with reference to the accompanying drawings.

### BRIEF DESCRIPTION OF THE DRAWINGS

FIG. 1 is a schematic exploded view of assemblies of the first embodiment of a container assembly for beverages or food of the present disclosure.

FIG. 2 is a schematic front view of the lid in FIG. 1.

FIG. 3 is a schematic perspective view of the magnetic connecting attachment in FIG. 1.

FIG. 4 is the right side schematic view of FIG. 3.

FIG. 5 is a partial right side schematic view of the container assembly for beverages or food in FIG. 1.

FIG. 6 is a schematic cross-sectional view along the X-X section in FIG. 5.

FIG. 7 is a partial front schematic view of the second embodiment of a container assembly for beverages or food of the present disclosure.

FIG. 8 is a partial right side schematic view of the third embodiment of a container assembly for beverages or food of the present disclosure.

FIG. 9 is a partial schematic perspective view of the fourth embodiment of a container assembly for beverages or food of the present disclosure.

FIG. 10 is a partial schematic perspective view of the fifth embodiment of a container assembly for beverages or food of the present disclosure.

FIG. 11 is a schematic perspective view of the sixth embodiment of a magnetic connecting attachment of the present disclosure.

FIG. 12 is a right side schematic cross-sectional view of FIG. 11.

FIG. 13 is a right side schematic cross-sectional view of the seventh embodiment of a magnetic connecting attachment of the present disclosure.

FIG. 14 is a right side schematic cross-sectional view of the eighth embodiment of a magnetic connecting attachment of the present disclosure.

FIG. 15 is a schematic perspective view of the ninth embodiment of a magnetic connecting attachment of the present disclosure.

FIG. 16 is a schematic exploded view of assemblies of the tenth embodiment of a container assembly for beverages or food of the present disclosure.

FIG. 17 is a schematic perspective exploded view of the magnetic connecting attachment in FIG. 16.

FIG. 18 is a schematic top view of the container assembly for beverages or food in FIG. 16.

FIG. 19 is a schematic cross-sectional view along the Y-Y section in FIG. 18.

FIG. 20 is a schematic cross-sectional view of the magnetic connecting attachment along the Z-Z section in FIG. 18.

FIG. 21 is a schematic perspective exploded view of the magnetic connecting member in FIG. 16.

FIG. 22 is a schematic perspective exploded view of the magnetic connecting attachment in FIG. 16 from another perspective.

FIG. 23 is a schematic perspective exploded view of the eleventh embodiment of a magnetic connecting attachment of the present disclosure.

### DETAILED DESCRIPTION OF THE INVENTION

The foregoing and other technical content, features, and effects of the present disclosure can be clearly presented in the following detailed descriptions of preferred embodiments with reference to drawings. It should be noted that, directional terms such as upper, lower, left, right, front, or back mentioned in the following embodiments is only a direction with reference to the drawings. Therefore, the used directional terms are used for descriptive purposes but are not intended to limit the present disclosure. In addition, in the following embodiments, same or similar assemblies use same or similar numbers.

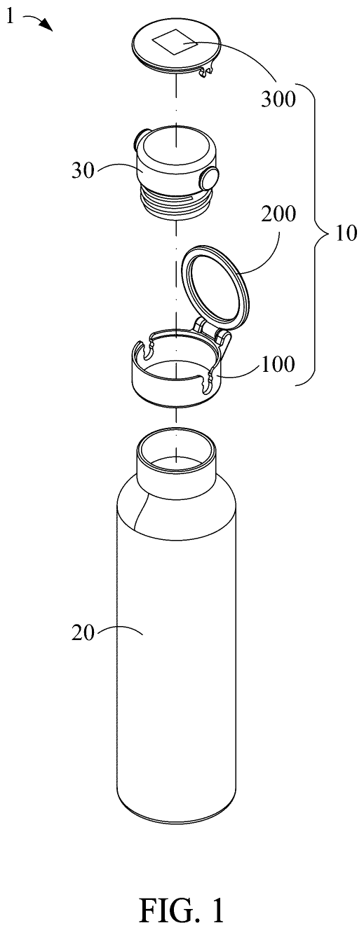

Referring to FIG. 1, FIG. 1 is a schematic exploded view of assemblies of the first embodiment of a container assembly for beverages or food of the present disclosure. In this embodiment, a container assembly for beverages or food 1 includes a magnetic connecting attachment 10 and a container for beverages or food to which the magnetic connecting attachment 10 is applied. The container for beverages or food includes a body portion 20 and a lid 30. In this embodiment, the container for beverages or food is, for example, a water bottle. However, in other possible embodiments, the container for beverages or food may alternatively be a container such as a sports water bottle, a thermos, a teapot, a storage jar, or even a pot. This is not limited in the present disclosure. In addition, the body portion 20 of the container for beverages or food is formed with accommodating space and an opening. The lid 30 is configured on the body portion 20, and is adapted to close at least one part of the opening. A user may operate the lid 30 to take out food, water, or beverage accommodated in the accommodating space. The magnetic connecting attachment 10 may be detachably configured on the lid 30, and is configured to be magnetically connected to a mobile device. The mobile device may be a portable electronic device such as a smart phone, a smart watch, Bluetooth headphones, a mobile power supply, a game console, a tablet computer, a personal digital assistant, or an ebook reader. This is not limited in the present disclosure.

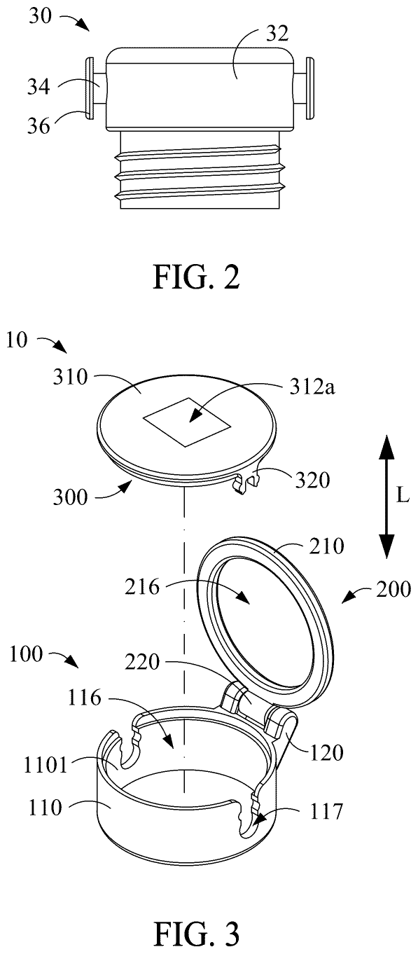

Referring to FIG. 2, FIG. 2 is a schematic front view of the lid in FIG. 1. As shown in the figure, the lid 30 includes a cover main body 32 and an engaging feature 34. The cover main body 32 is slightly in a cylindrical shape, and is configured to be detachably fitted to the body portion 20 via a thread formed at a lower end, to close the at least one part of the opening. The engaging feature 34 is, for example, a cylindrical member made of metal or plastic. In this embodiment, a quantity of engaging features may be two, and the two engaging features are symmetrically configured on the cover main body 32, for example, protruding from an outer peripheral wall of the cover main body 32. Therefore, when the lid 30 is configured on the body portion 20, the user may connect an accessory such as a handle or a string to the engaging feature 34, thereby lifting the lid 30 and the body portion 20 through the accessory. Preferably, the lid 30 may further include a limiting portion 36. The limiting portion 36 is, for example, a disk member whose outer diameter is greater than an outer diameter of the engaging feature 34. A quantity of limiting portions corresponds to a quantity of engaging features 34, and the limiting portion 36 is configured on a side of the engaging feature 34 away from the cover main body 32, to prevent the foregoing accessory from falling off from an outer end of the engaging feature 34.

It should be noted that, although an example in which the lid 30 is screwed with the body portion 20 through the thread to close the opening of the body portion 20 is used in this embodiment, the present disclosure is not limited thereto. In some possible embodiments, the cover main body 32 may include a main cover and a secondary cover. The main cover is formed with a taking-out opening for food, water, or beverage to pass through, and the secondary cover may be detachably or pivotally connected to the main cover. The main cover is maintained on the body portion 20, and the user only opens the secondary cover to take out food, water, or beverage in the body portion 20. In addition, the main cover may also be provided with an accessory such as a straw for convenient drinking of water or beverage. Alternatively, the main cover and the body portion 20 may form a single member, that is, the user may turn over the secondary cover to take out food and beverage inside the secondary cover.

Referring to FIG. 1 and FIG. 3 together, FIG. 3 is a schematic perspective view of the magnetic connecting attachment in FIG. 1. In this embodiment, the magnetic connecting attachment 10 includes a connection member 100 and a magnetic connecting member 200. The connection member 100 includes a main body 110, and the main body 110 is fitted to the lid 30. In addition, the magnetic connecting member 200 is pivotally connected to the main body 110, and includes a magnetic attraction portion 210. In this embodiment, the magnetic attraction portion 210 is, for example, in an annular shape, and the magnetic connecting member 200 is configured to be magnetically connected to a magnetic feature of the mobile device through the magnetic attraction portion 210. The magnetic feature is, for example, a magnetic array in a MAGSAFE interface.

Specifically, the main body 110 defines a passage 116. In this embodiment, the main body 110 is in a sleeve cylindrical shape, an inner peripheral wall 1101 of the main body 110 surrounds to form the passage 116, and a diameter of the passage 116 is substantially the same as a diameter of the cover main body 32. In this way, the main body 110 may be sleeved on the cover main body 32 through the passage 116, so that the main body 110 is fitted to the lid 30. In addition, the main body 110 is further formed with an engaging slot 117. In this embodiment, a quantity of engaging slots 117 is, for example, two, and the two engaging slots 117 are symmetrically configured along a circumferential direction of the main body 110. Through such a configuration, when the main body 110 is sleeved on the cover main body 32 through the passage 116, the engaging slot 117 may be engaged with the engaging feature 34 of the lid 30, thereby further improving the stability of combination between the connection member 100 and the lid 30.

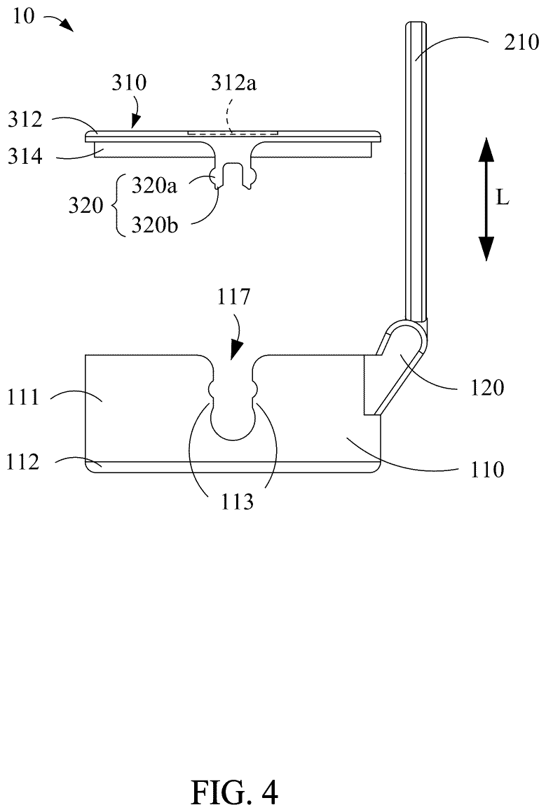

Referring to FIG. 3 and FIG. 4 together, FIG. 4 is a right side schematic view of FIG. 3. As shown in the figure, the main body 110 includes a top portion 111 and a bottom portion 112, the passage 116 extends along a longitudinal direction L, the longitudinal direction L may be defined as a direction from the top portion 111 to the bottom portion 112, and the engaging slot 117 is formed on the top portion 111 and extends along the longitudinal direction L. In addition, the connection member 100 further includes a pivoting base 120. The pivoting base 120 is, for example, fixedly arranged on the top portion of the main body 110. The magnetic connecting member 200 further includes a pivoting portion 220. The pivoting portion 220 is approximately in a cylindrical shape, and is fixedly arranged on an outer peripheral surface of the magnetic attraction portion 210. The connection member 100 and the magnetic connecting member 200 are respectively pivotally connected to each other through the pivoting base 120 and the pivoting portion 220. In other words, the magnetic connecting member 200 may be pivotally configured at the top portion 111 through the pivoting base 120 and the pivoting portion 220. Through such a configuration, when the magnetic connecting attachment 10 is fitted to the lid 30 through the connection member 100, the user may use the magnetic attraction portion 210 as a ring-shaped handle for lifting the lid 30 and the body portion 20. In addition, because a lower slot wall of the engaging slot 117 abuts against the engaging feature 34, the engaging feature 34 does not disconnect from an opening of the engaging slot 117 during lifting, thereby preventing the lid 30 or the body portion 20 from falling to the ground and being damaged.

In addition, the magnetic connecting attachment 10 may include a function of fixing the magnetic attraction portion 210 at a specific position. Specifically, a positioning member (not shown in the figure) for controlling relative pivoting between the pivoting base 120 and the pivoting portion 220 may be configured. The positioning member is, for example, a mechanical assembly, such as damping hinge, a positioning gear, a ratchet, or a torsion spring, that can implement stepped adjustment or stepless adjustment of a relative position. In this way, when the connection member 100 and the lid 30 are fitted to each other, or the lid 30 fitted to the connection member 100 is configured on the body portion 20 that does not contain food and beverage, even if a mobile device with a particular weight is magnetically connected to the magnetic attraction portion 210, the magnetic attraction portion 210 can still freely pivot relative to the main body 110 and be fixed at a position such as a horizontal position, a vertical position, or an inclined position. In other words, the user may use the lid 30 and the body portion 20 fitted to the magnetic connecting attachment 10 as a dedicated stand of the mobile device.

As shown in FIG. 4, in this embodiment, the main body 110 may further include an engaging portion 113. The engaging portion 113 is, for example, a part of a peripheral wall of the main body 110, and separately protrudes inward the engaging slot 117 along the circumferential direction of the main body 110. Through such a configuration, when the engaging feature 34 is embedded in the deepest part of the engaging slot 117, the main body 110 may slightly limit the engaging feature 34 from above the engaging feature 34 through the engaging portion 113, thereby further increasing the stability of combination between the connection member 100 and the lid 30.

Referring to FIG. 1, FIG. 3, and FIG. 4 together, to further prevent the connection member 100 from being detached from the lid 30 and improve visual and aesthetic integrity of the connection member 100, in this embodiment, the magnetic connecting attachment 10 may further include a fastening member 300, and the fastening member 300 is detachably connected to the main body 110 and selectively engaged with the engaging slot 117.

Specifically, the fastening member 300 may include a cover portion 310 and a fastening portion 320, and the cover portion 310 includes an upper cover portion 312 and a lower cover portion 314. As shown in FIG. 4, the upper cover portion 312 is in a disk shape, and an outer diameter of the upper cover portion is substantially the same as an outer diameter of the main body 110. The lower cover portion 314 is, for example, in an oblate circular tube shape, and is connected to a bottom surface of the upper cover portion 312, and an outer diameter of the lower cover portion 314 is substantially the same as an outer diameter of the passage 116. In addition, the fastening portion 320 is connected to the upper cover portion 312 and adjacent to the lower cover portion 314. In this embodiment, for example, the fastening portion 320 is configured on a radial outer side of the lower cover portion 314 on the cover portion 310 and includes an engaging end 320a and an abutting end 320b. A shape of the engaging end 320a corresponds to a slot wall of the engaging slot 117 along a circumferential direction, and a shape of the abutting end 320b corresponds to the engaging feature 34. Through such a configuration, after the engaging feature 34 is embedded in the engaging slot 117 from the top portion 111 of the main body 110, the user may fasten the fastening member 300 downward from above the connection member 100 along the longitudinal direction L, so that the lower cover portion 314 and the fastening portion 320 are respectively embedded in the passage 116 and the engaging slot 117, and a radial outer side of the upper cover portion 312 is substantially flush with a radial outer side of the main body 110. In this case, the engaging end 320a of the fastening portion 320 and the slot wall of the engaging slot 117 along the circumferential direction are engaged with each other, and the abutting end 320b abuts against an upper half of the engaging feature 34, which not only can further enhance combination strength between the lid 30 and the connection member 100, but also can improve visual and appearance integrity of the magnetic connecting attachment 10.

As shown in FIG. 3 and FIG. 4, in this embodiment, the upper cover portion 312 is further formed with an upper cover accommodating portion 312a. The upper cover accommodating portion 312a is, for example, a recessed portion. The user may configure wireless communication components such as an RFID chip of the EasyCard, an NFC chip of mobile payment, a small card with the invoice carrier barcode, and other small items in the upper cover accommodating portion 312a, so that the magnetic connecting attachment 10 can not only be magnetically connected and fixed to the mobile device, but also has functions of contactless sensing, mobile payment and storage of items. In addition, various textures, colors, and patterns may be printed or attached to a top surface of the upper cover portion 312, an outer peripheral surface of the main body 110, and even a surface of the magnetic attraction portion 210, thereby facilitating the user in creating a magnetic connecting attachment 10 in their desired style.

It should be noted that, although an example in which the fastening member 300 includes both the cover portion 310 and the fastening portion 320, and the cover portion 310 closes one end of the passage 116 is used in this embodiment, the present disclosure is not limited thereto. In some possible embodiments, the fastening member 300 may also include only the fastening portion 320, that is, the user only needs to insert the detachable fastening portion 320 in the engaging slot 117, so that an upper surface of the cover main body 32 is exposed when the engaging slot 117 is closed. This embodiment is adapted for some products that need to operate the upper surface of the cover main body 32, for example, the cover main body 32 that is provided with a suction nozzle or that is opened.

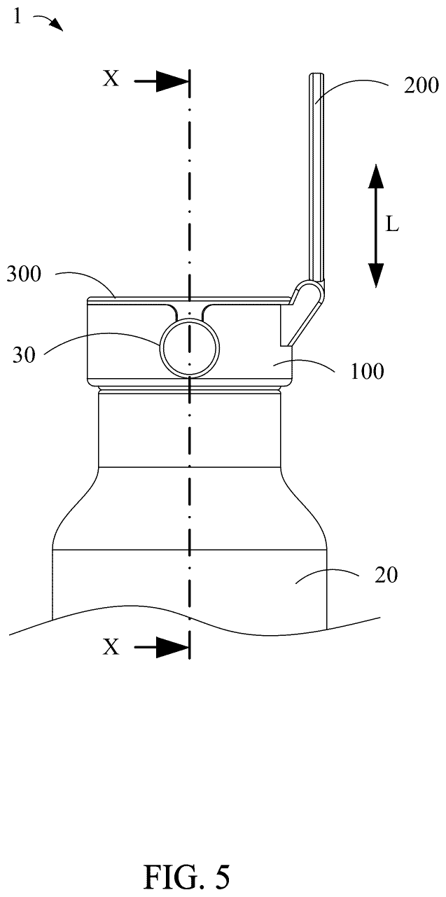

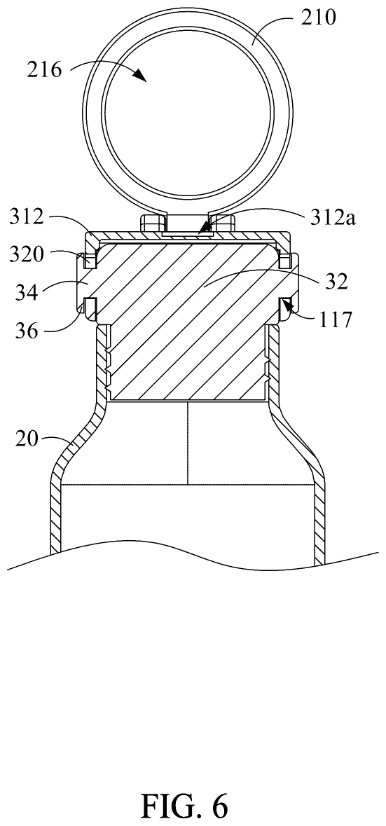

Referring to FIG. 5 and FIG. 6, FIG. 5 is a partial right side schematic view of a container assembly for beverages or food in FIG. 1, and FIG. 6 is a schematic cross-sectional view along an X-X section in FIG. 5. When intending to mount the magnetic connecting attachment 10 on the lid 30, the user may remove the lid 30 from the body portion 20, and move the connection member 100 from below the lid 30 toward the lid 30 along the longitudinal direction L, so that the main body 110 is sleeved on the cover main body 32, and the engaging slot 117 engages with the engaging feature 34. Then, the fastening member 300 is moved from above the lid 30 toward the lid 30 and the connection member 100 along the longitudinal direction L, so that the lower cover portion 314 is embedded in the passage 116, the fastening portion 320 is embedded in the engaging slot 117, and the fastening portion 320, the engaging slot 117, and the engaging feature 34 are engaged with each other. In this case, because the fastening portion 320 and the slot wall of the engaging slot 117 respectively limit the engaging feature 34 along the longitudinal direction L, and the cover main body 32 and the limiting portion 36 abut against the main body 110 at the same time in the radial direction, it can be ensured that there is no relative displacement or rotation between the connection member 100 and the lid 30. Finally, the lid 30 provided with the magnetic connecting attachment 10 is screwed into the body portion 20, so that the container assembly for beverages or food 1 has a function of magnetically connecting the mobile device. The user may magnetically connect the mobile device to the magnetic attraction portion 210, and fix the mobile device at a suitable location and angle through a pivoting relationship and a positioning relationship between the connection member 100 and the magnetic connecting member 200.

In addition, when removing the mobile device from the magnetic attraction portion 210, the user may directly insert their fingers through a through hole 216, so that the magnetic attraction portion 210 is used as the handle for lifting the lid 30 and the body portion 20.

It should be noted that, although an example in which the connection member 100 and the magnetic connecting member 200 are pivotally connected to each other respectively through the pivoting base 120 and the pivoting portion 220 is used in this embodiment, the present disclosure is not limited thereto. In some possible embodiments, one of the main body 110 and the magnetic connecting member 200 may include a pin, and the other of the main body 110 and the magnetic connecting member 200 may be formed with an insertion base corresponding to the pin. In this way, when intending to magnetically connect the mobile device, the user may insert the magnetic connecting member 200 into the main body 110, and remove the magnetic connecting member 200 from the main body 110 after use is completed. In other words, the magnetic connecting member 200 can be detachably connected to the main body 110, thereby reducing an extra volume occupied by the magnetic connecting member 200 when the mobile device is not used. In addition, in some possible embodiments, the main body 110 may also be formed with a plurality of insertion bases, and the user may insert the pin of the magnetic connecting member 200 into the corresponding insertion base based on actual requirements, or change the insertion base into a sliding slot or a sliding hole with a certain stroke, thereby improving a relative position of the magnetic connecting member 200 and the main body 110, all of which fall within the protection scope of the present disclosure.

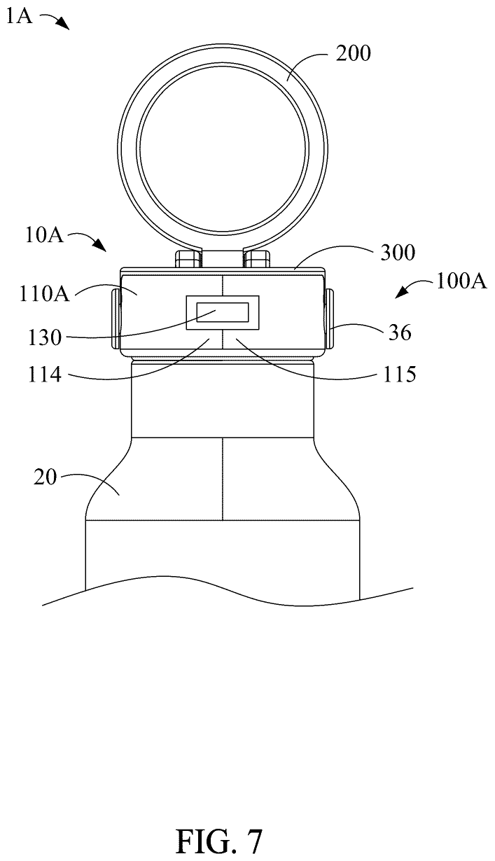

Referring to FIG. 7, FIG. 7 is a partial front schematic view of the second embodiment of a container assembly for beverages or food of the present disclosure. A container assembly for beverages or food 1A and a magnetic connecting attachment 10A thereof in this embodiment are approximately similar to the container assembly for beverages or food 1 and the magnetic connecting attachment 10 thereof in the first embodiment. A main difference is that a main body 110A of this embodiment includes a first end 114 and a second end 115, and the first end 114 and the second end 115 are detachably connected to each other.

Specifically, the main body 110 may be made of elastic plastic material or elastic rubber material, and is adapted to be deformed, and a connection member 100A of this embodiment further includes an operation portion 130. The operation portion 130 is, for example, a knob or a belt buckle. When the lid 30 and the connection member 100A are disassembled with each other, the first end 114 and the second end 115 may be disassembled with each other, so that the main body 110A is in a strip shape. When intending to use the magnetic connecting attachment 10A, the user may move the main body 110A upward from the bottom of the lid 30, so that the engaging slot 117 is embedded with the engaging feature 34, and the first end 114 and the second end 115 bypass two sides of the lid 30 to abut against each other. In this case, the main body 110A surrounds to form the passage 116, and covers the cover main body 32, and the user may adjust a size of the passage 116 through the operation portion 130, or may unlock the first end 114 and the second end 115, to restore the main body 110A in an original strip shape. Through such a configuration, the user can utilize the same connection member 100A to accommodate a plurality of lids 30 with different outer diameters, thereby enhancing the flexibility of using the magnetic connecting attachment 10A.

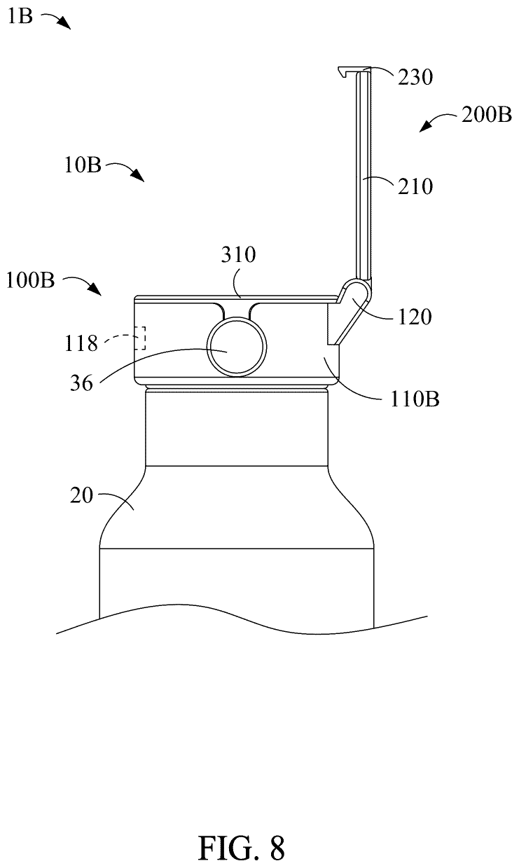

Referring to FIG. 8, FIG. 8 is a partial right side schematic view of the third embodiment of a container assembly for beverages or food of the present disclosure. A container assembly for beverages or food 1B and a magnetic connecting attachment 10B thereof in this embodiment are approximately the same as the container assembly for beverages or food 1 and the magnetic connecting attachment 10 thereof in the first embodiment, and a main difference is that a magnetic connecting member 200B in this embodiment includes a lock portion 230, and a main body 110B is formed with a positioning slot 118 corresponding to the lock portion 230.

As shown in FIG. 8, the lock portion 230 is, for example, an assembly with a hook structure at one end, and is configured at an end of the magnetic attraction portion 210 away from the pivoting base 120. The positioning slot 118 is configured at a position of the main body 110B away from the pivoting base 120 along a circumferential direction. Through such a configuration, when ending using the mobile device, or intending to fold the magnetic attraction portion 210, the user may pivot the magnetic attraction portion 210 relative to the pivoting base 120 to a horizontal position in FIG. 8, so that the lock portion 230 is embedded in the positioning slot 118, thereby preventing the magnetic connecting member 200B from pivoting relative to the connection member 100B and reducing a risk of the magnetic attraction portion 210 being unfolded and colliding with other objects and being damaged. In addition, in some other possible embodiments, alternatively, the positioning slot 118 may be selectively formed on the upper cover portion 312, to fix the magnetic attraction portion 210.

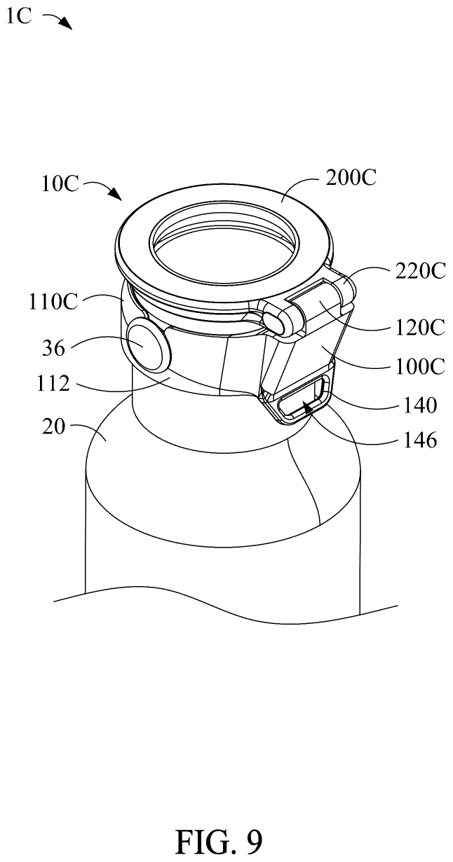

Referring to FIG. 9, FIG. 9 is a partial schematic perspective view of the fourth embodiment of a container assembly for beverages or food of the present disclosure. A main difference between a container assembly for beverages or food IC and a magnetic connecting attachment 10C thereof in this embodiment and the container assembly for beverages or food and the magnetic connecting attachment thereof in the previous embodiments is that a connection member 100C in this embodiment further includes a connection portion 140, and the connection portion 140 is connected to a main body 110C, and is formed with a hole 146.

Specifically, in addition to the foregoing manner of using the magnetic attraction portion 210 as the ring-shaped handle for lifting a container for beverages or food, in this embodiment, the connection member 100C may also be formed with the hole 146 for a connection object such as a string, a belt, or a chain to pass through. In this way, the user may carry the container assembly for beverages or food 1C on a body side through these connection objects, so that it is more convenient to carry the container assembly for beverages or food 1C.

It should be noted that, although an example in which the connection portion 140 is fixedly arranged at the bottom portion 112 of the main body 110C and is located below the pivoting base 120C is used in this embodiment, the present disclosure is not limited thereto. In some possible embodiments, the connection portion 140 may also be pivotally connected to the main body 110C, and a pivot connection position may be any position on the top portion 111 or the outer peripheral wall, thereby preventing a problem of excessive local stress on a structure.

In addition, different from the connection member 100 and the magnetic connecting member 200 in the first embodiment, a pivoting base 120C in this embodiment passes through a recessed portion formed by a pivoting portion 220C. In other words, the pivoting portion 220C clamps the pivoting base 120C from both sides of the pivoting base 120C, thereby further improving the stability of the magnetic connecting member 200C when the mobile device is magnetically connected.

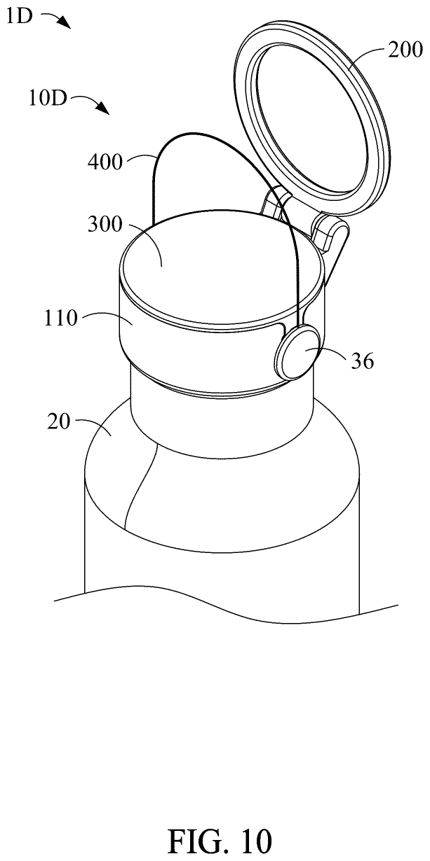

Referring to FIG. 10, FIG. 10 is a partial schematic perspective view of the fifth embodiment of a container assembly for beverages or food of the present disclosure. A container assembly for beverages or food 1D and a magnetic connecting attachment 10D thereof in this embodiment are approximately similar to the container assembly for beverages or food 1 and the magnetic connecting attachment 10 thereof in the first embodiment. A main difference is that the magnetic connecting attachment 10D further includes a lifting member 400, and two ends of the lifting member 400 are respectively connected to two sides of the main body 110.

Specifically, the lifting member 400 in this embodiment is, for example, a string, a hard plastic material, or an alloy material, and the two ends are respectively connected to the engaging feature 34, thereby providing the user with an additional lifting option in addition to the magnetic attraction portion 210. In addition, because a size of the limiting portion 36 is larger than a size of the engaging feature 34, the lifting member 400 does not disconnect from a free end of the engaging feature 34. It should be noted that, in other possible embodiments, the lifting member 400 may also be directly connected to the outer peripheral wall of the main body 110 or the upper cover portion 312 of the fastening member 300, or may be integrally formed with one of the peripheral wall of the main body 110 and the upper cover portion 312 of the fastening member 300, and may also facilitate lifting for the user.

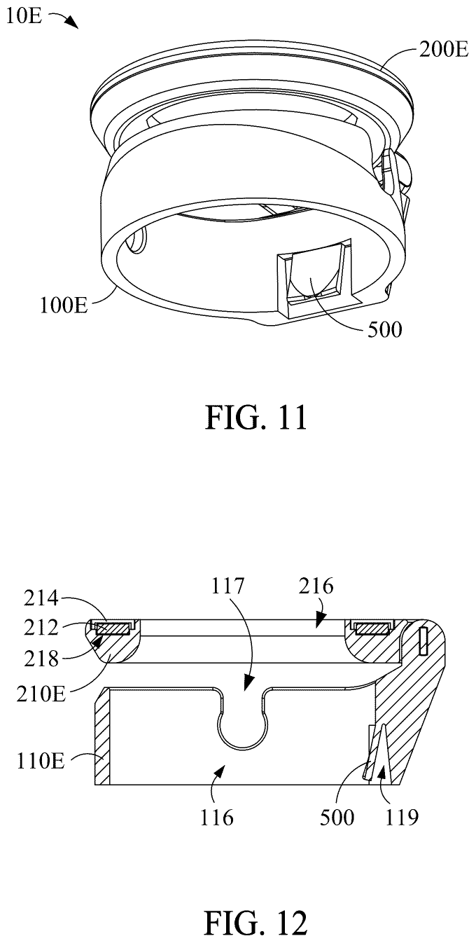

Referring to FIG. 11 and FIG. 12, FIG. 11 is a schematic perspective view of the sixth embodiment of a magnetic connecting attachment of the present disclosure, and FIG. 12 is a right side schematic cross-sectional view of FIG. 11. A main difference between a magnetic connecting attachment 10E in this embodiment and the foregoing magnetic connecting attachment is that the magnetic connecting attachment 10E further includes a holding member 500, and the holding member 500 is configured on an inner peripheral wall of a main body 110E.

Specifically, to improve convenience for the user to assemble the magnetic connecting attachment 10E and the lid 30 together, an avoidance slot 119 is formed on the inner peripheral wall of the main body 110E in this embodiment, and the size of the passage 116 is slightly larger than a size of the lid 30. In addition, the holding member 500 is, for example, made of an alloy or plastic that is elastic and that is adapted to be deformed, or is integrally formed with the main body 110E. In addition, a part of the holding member 500 protrudes into the passage 116, and another part is accommodated in the avoidance slot 119. Through such a configuration, when the user sleeves a connection member 100E upward from the bottom of the lid 30, the lid 30 may smoothly enter a large passage 116, and until a lower end of the cover main body 32 abuts against the holding member 500, the holding member 500 conforms to an outer peripheral surface of the cover main body 32 to deform, and partially retracts into the avoidance slot 119. Therefore, the cover main body 32 is held at a specific position along a radial direction, and it is ensured that there is no relative displacement between the cover main body 32 and the main body 110. When intending to remove the magnetic connecting attachment 10F from the lid 30, the user only needs to pull the holding member 500 from a lower end of the passage 116, to generate a gap between the holding member 500 and the cover main body 32, so that the lid 30 can be pulled out from an upper end of the connection member 100.

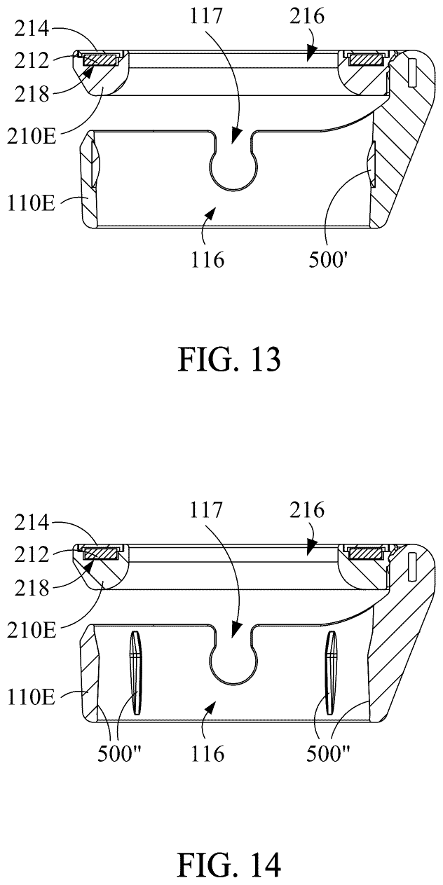

In addition, although only one holding member 500 is provided in this embodiment and the avoidance slot 119 is provided to elastically deform the holding member 500 to hold the lid 30, the present disclosure is not limited thereto. In other possible embodiments, a holding member 500′ may be two convex points with curved surfaces as shown in FIG. 13, and the holding member 500′ is symmetrically configured on an inner peripheral wall of the main body 110E relative to the engaging slot 117. Alternatively, a plurality of rib-shaped holding members 500″ may be provided as shown in FIG. 14, and the holding members 500″ are configured on the inner peripheral wall of the main body 110E at equal intervals with the engaging slot 117 along the circumferential direction, so that this can also limit displacement of the lid 30.

In addition, a magnetic connecting member 200E in this embodiment includes a magnetic attraction portion 210E, and in addition to the through hole 216, the magnetic attraction portion 210E further forms a magnetic slot 218, and the magnetic slot 218 is approximately in a T shape when viewed from a cross-section. Moreover, the magnetic attraction portion 210E further includes a magnet 212 and a magnetic cover portion 214. The magnet 212 is, for example, an annular sheet-shaped permanent magnetic, and a size of the magnet 212 corresponds to a size of a lower slot portion of the magnetic slot 218. The user may configure the magnet 212 in the lower slot portion of the magnetic slot 218, and then embed the magnetic cover portion 214 in an upper slot portion of the magnetic slot 218. Through such a configuration, if the magnet 212 is damaged or demagnetized, the magnet 212 can be removed from the magnetic slot 218 as soon as possible and replaced, thereby improving maintenance convenience.

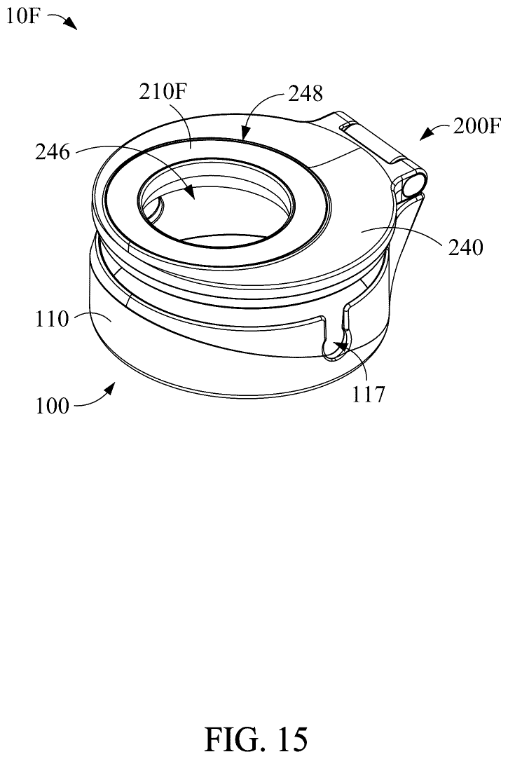

Referring to FIG. 15, FIG. 15 is a schematic perspective view of the ninth embodiment of a magnetic connecting attachment of the present disclosure. A main difference between a magnetic connecting attachment 10F in this embodiment and the foregoing magnetic connecting attachment is that a magnetic connecting member 200F further includes a base portion 240, and a magnetic attraction portion 210F is mounted on the base portion 240.

Specifically, because magnetic features of many mobile devices have fixed sizes and specifications (for example, the MAGSAFE interface) but the user may use a container for beverages or food with a large diameter of the opening to enable the container for beverages or food with the large diameter of the opening to fix the mobile device through the magnetic connecting attachment 10F, in this embodiment, the magnetic connecting member 200F includes the base portion 240. The base portion 240 is, for example, made of plastic, is slightly in a disk shape, and is formed with a through hole 246 and a magnetic accommodating portion 248. A size of the through hole 246 is substantially the same as a size of the through hole 216. The magnetic accommodating portion 248 is, for example, an annular recessed portion, and the magnetic attraction portion 210F is configured in the magnetic accommodating portion 248 in a manner such as embedding or locking. In this way, the magnetic connecting attachment 1OF may be adapted for the lid 30 with a large size, thereby improving generality. In addition, as shown in FIG. 15, the magnetic attraction portion 210F and the magnetic accommodating portion 248 are eccentrically configured on the base portion 240. However, in other possible embodiments, the magnetic attraction portion 210F may also be concentrically configured on the base portion 240. This is not limited in the present disclosure.

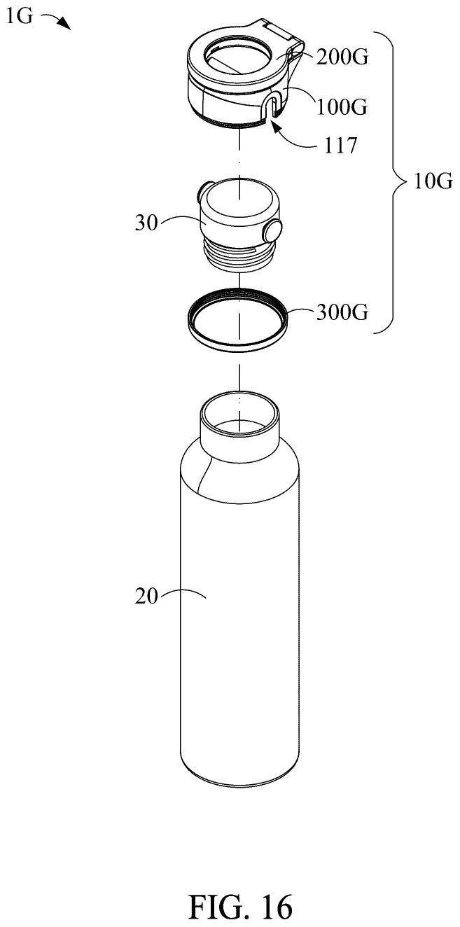

Referring to FIG. 16, FIG. 16 is a schematic exploded view of assemblies of the tenth embodiment of a container assembly for beverages or food of the present disclosure. A container assembly for beverages or food 1G in this embodiment is approximately similar to the container assembly for beverages or food 1 in the first embodiment, and a main difference is that in a magnetic connecting attachment 10G in this embodiment, the opening of the engaging slot 117 is changed to be arranged downward.

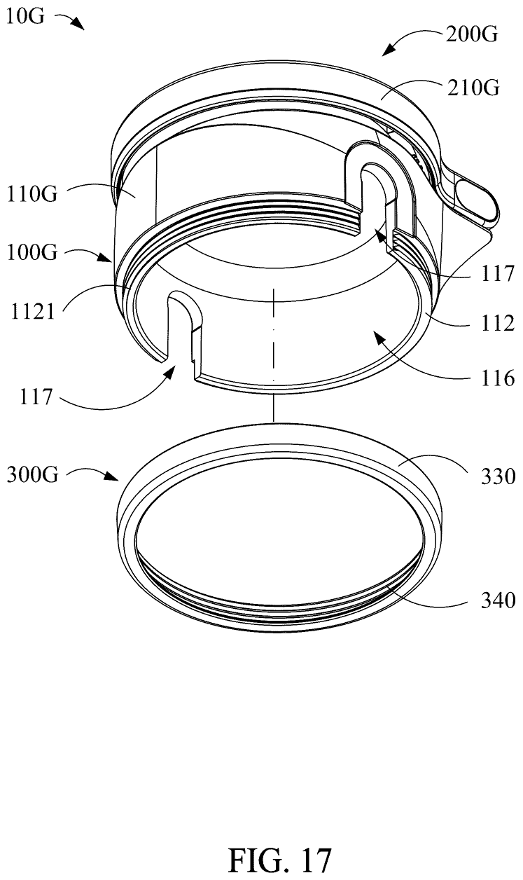

Specifically, referring to FIG. 17, FIG. 17 is a schematic perspective exploded view of a magnetic connecting attachment in FIG. 16. In a connection member 100G in this embodiment, a first combination portion 1121 may be arranged at a bottom portion 112 of a main body 110G. A fastening member 300G in this embodiment may include an annular body 330, and is provided with a second combination portion 340, and the fastening member 300G may be detachably connected to the first combination portion 1121 of the main body 110G through the second combination portion 340. In this embodiment, the first combination portion 1121 of the main body 110G and the second combination portion 340 of the fastening member 300G may be in an internal thread structure and an external thread structure that can be screwed with each other. For example, the first combination portion 1121 is in the external thread structure and the second combination portion 340 is in the internal thread structure. Based on this, the first combination portion 1121 and the second combination portion 340 can provide a structure that can be stably fitted to each other and can be easily disassembled within a short combination range. In another embodiment, the first combination portion 1121 of the main body 110G and the second combination portion 340 of the fastening member 300G may alternatively be in a fastening member structure, may be fitted to a magnetic function, or the like. This is not limited in the present disclosure.

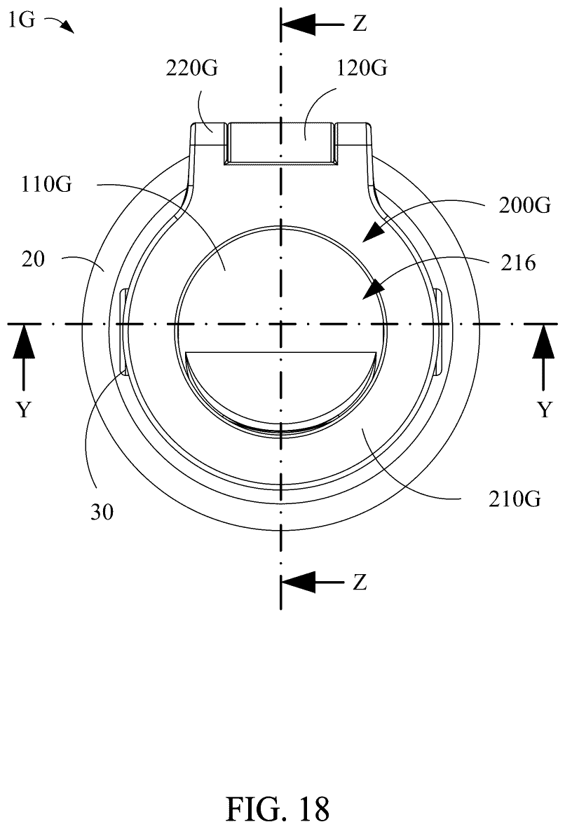

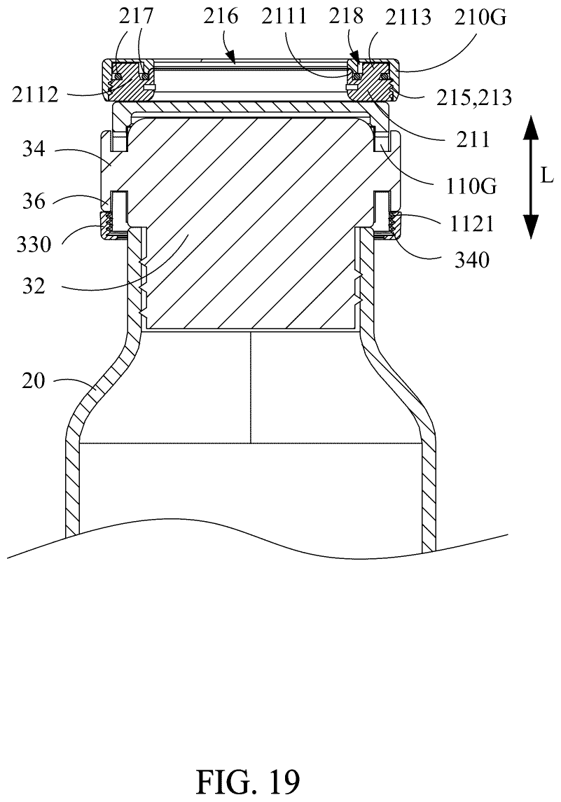

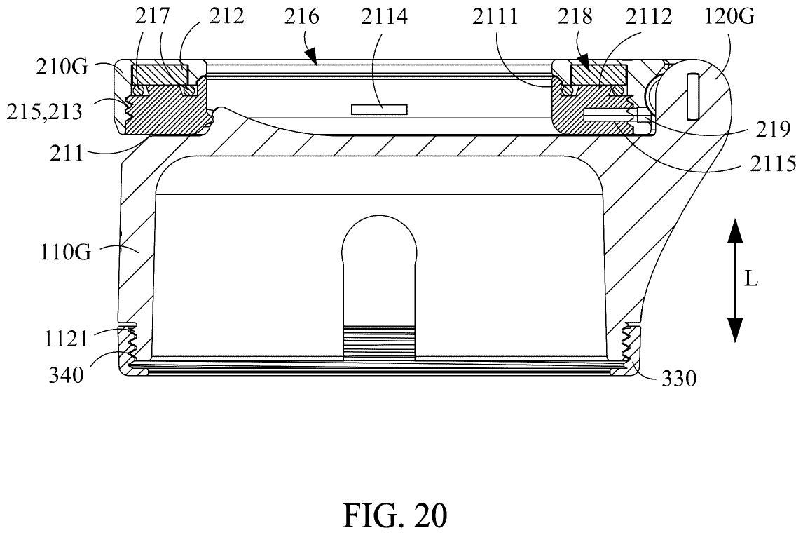

Referring to FIG. 16 to FIG. 20 together, FIG. 18 is a schematic top view of a container assembly for beverages or food in FIG. 16, FIG. 19 is a schematic cross-sectional view along a Y-Y section in FIG. 18, and FIG. 20 is a schematic cross-sectional view of a magnetic connecting attachment along a Z-Z section in FIG. 18. Because the opening of the engaging slot 117 is arranged at a position opposite to a position at which a magnetic connecting member 200G is connected to the connection member 100G, the opening of the engaging slot 117 is opened downward, that is, the engaging slot 117 extends along the longitudinal direction L to form the opening at the bottom portion 112. Therefore, when the magnetic connecting attachment 10G is fitted to the engaging slot 117 the lid 30 through the connection member 100G, the user may sleeve the main body 110G of the connection member 100G on the cover main body 32 of the lid 30 through the passage 116, the engaging feature 34 of the lid 30 aligns with the engaging slot 117 of the main body 110G, and the limiting portion 36 of the lid 30 passes through the engaging slot 117. The fastening member 300G is fitted to the first combination portion 1121 of the main body 110G through the second combination portion 340, so that the annular body 330 of the fastening member 300G can close the opening of the engaging slot 117, to limit the engaging feature 34 of the lid 30 in the engaging slot 117, and the engaging feature 34 abuts against an upper slot wall of the engaging slot 117. In addition, the annular body 330 of the fastening member 300G abuts against the limiting portion 36 of the lid 30, so that the connection member 100G and the fastening member 300G can be stably fitted to the lid 30, and the connection member 100G, the fastening member 300G, and the lid 30 are not easily to shake relative to each other.

In this way, in this embodiment, even if the lid 30 with a large manufacturing tolerance is used in the magnetic connecting attachment 10G, or even if the engaging feature 34 of the lid 30 is slightly deformed, the magnetic connecting attachment 10G can be sufficiently stably fitted to the lid 30, and does not easily to shake relative to each other. In addition, a case in which the magnetic connecting attachment 10G and the lid 30 are abraded or a sound is generated due to collision is reduced. Therefore, when the container assembly for beverages or food IG in this embodiment is used, the user can experience a better operating feel and a mute effect. Specifically, when the first combination portion 1121 of the main body 110G and the second combination portion 340 of the fastening member 300G can be screwed with each other, a degree of combination between the main body 110G and the fastening member 300G can further be adjusted based on the manufacturing tolerance of the lid 30. For example, when the lid 30G is large, the first combination portion 1121 of the main body 110G and the second combination portion 340 of the fastening member 300G do not need to be completely screwed, so that a gap is provided between the bottom portion 112 of the main body 110G and a top surface of the annular body 330, to have a better effect of stably combining the magnetic connecting attachment 10G with the lid 30.

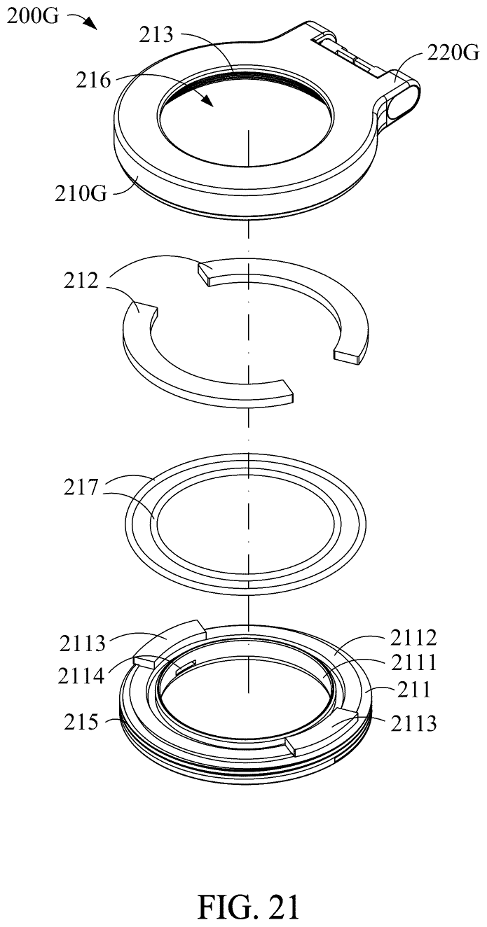

In addition, referring to FIG. 19 to FIG. 21, FIG. 21 is a schematic perspective exploded view of a magnetic connecting member in FIG. 16. The magnetic connecting member 200G in this embodiment has a magnetic attraction portion 210G and a cover 211, and the magnetic attraction portion 210G has the through hole 216 through which fingers of the user can pass, and the magnetic attraction portion 210G has a third combination portion 213. The cover 211 is in an annular shape, and has a fourth combination portion 215. The cover 211 may be fitted to the third combination portion 213 of the magnetic attraction portion 210G through the fourth combination portion 215. The magnetic slot 218 is formed inside the magnetic attraction portion 210G and the cover 211 for accommodating the at least one magnetic 212. Through such a configuration, the magnetic 212 is accommodated in the magnetic attraction portion 210G and the cover 211 that are assembled and combined, so that when the magnetic connecting member 200G is to be scrapped, the magnetic attraction portion 210G and the cover 211 are further disassembled, to take out the magnetic 212. Therefore, compared to a magnetic connecting member formed by plastic injection molding to encapsulate the magnet 212, the magnetic connecting member 200G of this embodiment better aligns with the environmental protection concept of recycling and reuse.

In this embodiment, the third combination portion 213 of the magnetic attraction portion 210G and the fourth combination portion 215 of the cover 211 are selected to be in an internal thread structure and an external thread structure that can be screwed with each other. For example, the third combination portion 213 is in the internal thread structure arranged on an inner peripheral wall of the magnetic attraction portion 210G, and the fourth combination portion 215 is in the external thread structure arranged on an outer peripheral wall of the cover 211. However, this is not limited thereto.

In addition, the magnetic connecting member 200G in this embodiment may further include at least one leak-proof ring 217, to enable the leak-proof ring 217 to seal the magnetic slot 218. In other words, the magnetic attraction portion 210G and the cover 211 are liquid-tightly combined, so that external liquid does not easily penetrate into the magnetic slot 218, which can effectively reduce a rust rate of the magnet 212, thereby maintaining a MAGSAFE functionality.

Referring to FIG. 20 and FIG. 21, in an embodiment of the present disclosure, a quantity of leak-proof rings 217 may be selected to be two, and the magnet 212 is arranged between the foregoing two leak-proof rings 217. In addition, the cover 211 may have an inner annular wall 2111. When the cover 211 is fitted to the magnetic attraction portion 210G, the inner annular wall 2111 may abut against an inner peripheral surface (a circumferential wall of the through hole 216) of the magnetic attraction portion 210G. A top surface of the cover 211 may have an annular boss 2112 for the magnet 212 to be placed and arranged, and at least one stopper 2113 may be further connected to the annular boss 2112. One leak-proof ring 217 may be arranged between the annular boss 2112 and the inner annular wall 2111, and the other leak-proof ring 217 may be arranged at an outer periphery of the annular boss 2112 and is partially blocked below the stopper 2113. Through such a configuration, operating convenience of mounting the two leak-proof rings 217 can be improved, and the two leak-proof rings 217 can be easily maintained and fixed at a preset position. In addition, in a process of screwing the cover 211 to the magnetic attraction portion 210G, the two leak-proof rings 217 may further be pressed to be elastically deformed, to improve an effect of sealing the magnetic slot 218.

In addition, to facilitate assembling and combining the cover 211 with the magnetic attraction portion 210G or disassembling the cover 211 from the magnetic attraction portion 210G, the cover 211 may be provided with two spaced apart grooves 2114 on the inner annular wall 2111. Based on this, the user may engage and position a tool in the two grooves 2114, and drive the cover 211 to rotate relative to the magnetic attraction portion 210G for combination or removal.

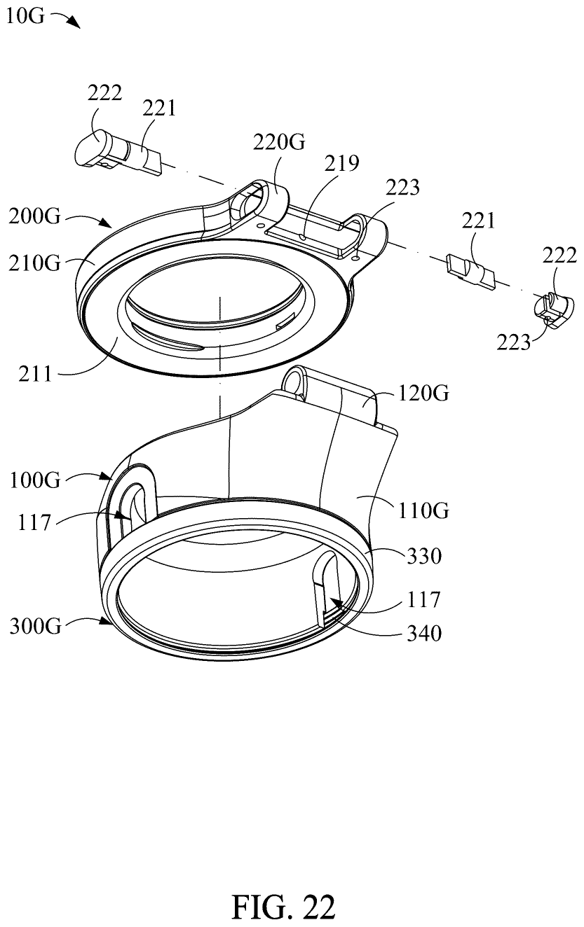

Referring to FIG. 20 and FIG. 22, FIG. 22 is a schematic perspective exploded view of the magnetic connecting attachment in FIG. 16 from another perspective. In this embodiment, the magnetic attraction portion 210G and the cover 211 may be provided with a pin hole 219 and a pin hole 2115. The pin hole 219 provided in the magnetic attraction portion 210G runs through the third combination portion 213 of the magnetic attraction portion 210G, and the pin hole 2115 provided in the cover 211 runs through the fourth combination portion 215 of the cover 211. When the cover 211 is fitted to the magnetic attraction portion 210G, the pin hole 2115 of the cover 211 is aligned with the pin hole 219 of the magnetic attraction portion 210G for inserting a positioning pin (not shown in the figure), thereby preventing the cover 211 from reversing relative to the magnetic attraction portion 210G and loosened. When the cover 211 is intended to be removed, a striker may be used to hit the positioning pin, so that the positioning pin is ejected from the inner annular wall 2111 of the cover 211. In other words, the cover 211 may be rotated to separate the cover 211 from the magnetic attraction portion 210G.

In addition, referring to FIG. 22, the pivoting base 120G in this embodiment passes through a recessed portion formed by the pivoting portion 220G, and the magnetic connecting member 200G in this embodiment includes two linkage sheets 221 and two positioning plugs 222. During assembly, the two linkage sheets 221 are respectively inserted into a metal hinge structure in the pivoting base 120G from two sides, and then the two positioning plugs 222 are inserted into the pivoting portion 220G and are fitted to the corresponding linkage sheets 221. Each of the two positioning plugs 222 is provided with a pin hole 223, and the pivoting portion 220G is also provided with two pin holes 223, to respectively correspond to the pin holes 223 of the two positioning plugs 222. Therefore, after the two positioning plugs 222 are inserted into the pivoting portion 220G, the pin holes 223 of the two positioning plugs 222 are respectively aligned with the two pin holes 223 of the pivoting portion 220G, and the two pin holes are for inserting the positioning pin respectively. In this way, the stability of combination between the two positioning plugs 222 and the pivoting portion 220G is enhanced, and the two positioning plugs 222 are not easily to loosen or be disconnected after the magnetic connecting attachment 10G is used for a long time.

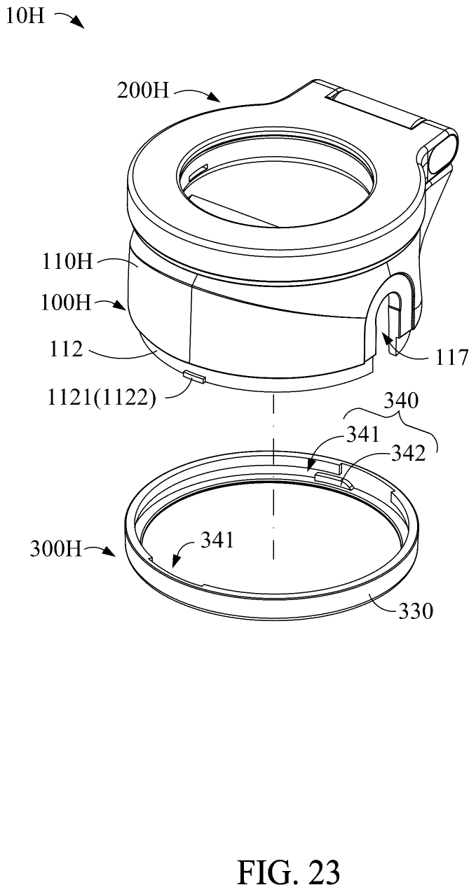

Referring to FIG. 23, FIG. 23 is a schematic perspective exploded view of

the eleventh embodiment of a magnetic connecting attachment of the present disclosure. A magnetic connecting attachment 10H in this embodiment is approximately similar to the magnetic connecting attachment 10G of the tenth embodiment, and a main difference is that a structure of the first combination portion 1121 is different from a structure of the second combination portion 340.

Specifically, in this embodiment, the first combination portion 1121 of the main body 110H may be at least one bump 1122, the second combination portion 340 of a fastening member 300H may be at least one L-shaped slot 341 arranged on the annular body 330, and a guide block 342 is configured in the L-shaped slot 341. Based on this, the fastening member 300H may be positioned and sleeved in the bump 1122 of the main body 110H through the L-shaped slot 341, and then the fastening member 300H rotates relative to the main body 110H, so that the bump 1122 may follow guidance of the guide block 342 to tighten the fastening member 300H toward the main body 110H. Through such a configuration, the magnetic connecting attachment 10H in this embodiment can also provide, in a simple structure, functions of being quickly disassembled and stably fitted to the lid 30.

The present disclosure is disclosed through the foregoing preferred embodiments. However, a person skilled in the art should understand that the foregoing embodiments are merely used for describing the present disclosure, and should not be interpreted as limiting the scope of the present disclosure. In addition, it should be noted that, any equivalent change or replacement with the foregoing implementations should be considered as falling within the scope of the present disclosure. The technical features of the foregoing embodiments may be properly combined, replaced, omitted, and changed without generating a concept conflict or a structural conflict. Therefore, the protection scope of the present disclosure shall be subject to the protection scope of the present disclosure.

What is claimed is:

1. A magnetic connecting attachment, adapted for a lid and a mobile device, the lid comprising an engaging feature, and the magnetic connecting attachment comprising:
a main body, formed with an engaging slot, the main body being adapted to be arranged on the lid, and the engaging slot being adapted to be engaged with the engaging feature; and
a magnetic connecting member, pivotally or detachably connected to the main body, and being adapted to be magnetically connected to the mobile device.

2. The magnetic connecting attachment according to claim 1, wherein the main body defines a passage, and the main body is adapted to sleeve the lid through the passage.

3. The magnetic connecting attachment according to claim 2, wherein the passage extends along a longitudinal direction, the main body comprises a top portion, the engaging slot is formed on the top portion and extends along the longitudinal direction, and the magnetic connecting member is pivotally or detachably configured on the top portion.

4. The magnetic connecting attachment according to claim 1, wherein the main body further comprises an engaging portion, and the engaging portion protrudes inward the engaging slot.

5. The magnetic connecting attachment according to claim 2, further comprising a fastening member, the fastening member being detachably connected to the main body and selectively engaged with the engaging slot.

6. The magnetic connecting attachment according to claim 5, wherein the fastening member comprises:
a cover portion, comprising an upper cover portion and a lower cover portion, an outer diameter of the upper cover portion being substantially the same as an outer diameter of the main body, the lower cover portion being connected to the upper cover portion, and an outer diameter of the lower cover portion being substantially the same as an outer diameter of the passage; and
a fastening portion, connected to the upper cover portion and adjacent to the lower cover portion, a shape of a part of the fastening portion corresponding to a slot wall of the engaging slot, and a shape of another part of the fastening portion corresponding to the engaging feature.

7. The magnetic connecting attachment according to claim 6, wherein the upper cover portion is formed with an upper cover accommodating portion.

8. The magnetic connecting attachment according to claim 1, wherein the magnetic connecting member comprises a lock portion, the main body is formed with a positioning slot, and the lock portion is selectively embedded in the positioning slot.

9. The magnetic connecting attachment according to claim 1, further comprising a lifting member, and two ends of the lifting member being respectively connected to two sides of the main body.

10. The magnetic connecting attachment according to claim 1, further comprising a connection portion, the connection portion being connected to the main body and being formed with a hole.

11. The magnetic connecting attachment according to claim 2, further comprising a holding member, the holding member being configured on an inner peripheral wall of the main body, a size of the passage being slightly larger than a size of the lid, and at least one part of the holding member protruding inward the passage.

12. The magnetic connecting attachment according to claim 11, wherein the inner peripheral wall is formed with an avoidance slot, and another part of the holding member is accommodated in the avoidance slot.

13. The magnetic connecting attachment according to claim 2, wherein the main body is adapted to be deformed and comprises a first end and a second end, the first end and the second end are detachably connected to each other, and when the first end abuts against the second end, the main body surrounds to form the passage.

14. The magnetic connecting attachment according to claim 2, wherein the passage extends along a longitudinal direction, the main body comprises a top portion and a bottom portion, the magnetic connecting member is pivotally or detachably configured on the top portion, and the engaging slot extends along the longitudinal direction to form an opening at the bottom portion.

15. The magnetic connecting attachment according to claim 14, further comprising a fastening member, the fastening member comprising an annular body and being provided with a second combination portion, the bottom portion of the main body being provided with a first combination portion, the fastening member being detachably connected to the first combination portion of the main body through the second combination portion, the engaging feature of the lid abutting against an upper slot wall of the engaging slot, a limiting portion of the lid passing through the engaging slot, and the annular body abutting against the limiting portion.

16. The magnetic connecting attachment according to claim 15, wherein the first combination portion of the main body and the second combination portion of the fastening member are in an internal thread structure and an external thread structure that are screwed with each other.

17. The magnetic connecting attachment according to claim 15, wherein the first combination portion of the main body is at least one bump, the second combination portion of the fastening member is at least one L-shaped slot arranged on the annular body, a guide block is configured in the L-shaped slot, the fastening member is positioned and sleeved in the bump of the main body through the L-shaped slot, and when the fastening member rotates relative to the main body, the bump follows guidance of the guide block to tighten the fastening member toward the main body.

18. The magnetic connecting attachment according to claim 1, wherein the magnetic connecting member has a magnetic attraction portion and a cover, the magnetic attraction portion has a third combination portion, the cover has a fourth combination portion, the cover is fitted to the third combination portion of the magnetic attraction portion through the fourth combination portion, and a magnetic slot is formed inside the magnetic attraction portion and the cover for accommodating a magnet.

19. The magnetic connecting attachment according to claim 18, wherein the third combination portion of the magnetic attraction portion and the fourth combination portion of the cover are in an internal thread structure and an external thread structure that are screwed with each other, each of the magnetic attraction portion and the cover is provided with a pin hole, the pin hole provided on the magnetic attraction portion runs through the third combination portion, the pin hole provided on the cover runs through the fourth combination portion, and when the cover is fitted to the magnetic attraction portion, the pin hole of the cover is aligned with the pin hole of the magnetic attraction portion for inserting a positioning pin.

20. The magnetic connecting attachment according to claim 18, wherein the magnetic connecting member comprises at least one leak-proof ring, to enable the leak-proof ring to seal the magnetic slot.

21. The magnetic connecting attachment according to claim 20, wherein a quantity of leak-proof rings is two, the cover has an inner annular wall, when the cover is fitted to the magnetic attraction portion, the inner annular wall abuts against an inner peripheral surface of the magnetic attraction portion, the cover has an annular boss for the magnet to be placed and arranged, at least one stopper is connected to the annular boss, one leak-proof ring is arranged between the annular boss and the inner annular wall, and the other leak-proof ring is arranged at an outer periphery of the annular boss and is partially blocked below the stopper.

22. The magnetic connecting attachment according to claim 1, further comprising a pivoting base, the pivoting base being fixedly connected to the main body, the magnetic connecting member comprising a pivoting portion and two positioning plugs, the pivoting base passing through a recessed portion formed by the pivoting portion, the two positioning plugs being arranged in the pivoting portion, each of the two positioning plugs being provided with a pin hole, the pivoting portion being provided with two pin holes to respectively correspond to the pin holes of the two positioning plugs, and the two pin holes being for inserting a positioning pin respectively.

23. A lid assembly, adapted for a mobile device, comprising:
a lid, comprising an engaging feature; and
a magnetic connecting attachment, comprising:
a main body, formed with an engaging slot, the main body being adapted to be arranged on the lid, and the engaging slot being adapted to be engaged with the engaging feature; and
a magnetic connecting member, pivotally or detachably connected to the main body, and being adapted to be magnetically connected to the mobile device.

24. The lid assembly according to claim 23, wherein the lid further comprises a limiting portion, the limiting portion is configured on the engaging feature, a size of the engaging feature is substantially the same as a size of at least one part of the engaging slot, and a size of the limiting portion is larger than a size of the at least one part of the engaging slot.

25. The lid assembly according to claim 23, wherein the main body defines a passage, and the main body is adapted to sleeve the lid through the passage.

26. The lid assembly according to claim 25, wherein the passage extends along a longitudinal direction, the main body comprises a top portion and a bottom portion, the magnetic connecting member is pivotally or detachably configured on the top portion, and the engaging slot extends along the longitudinal direction to form an opening at the bottom portion.

27. The lid assembly according to claim 26, further comprising a fastening member, the fastening member comprising an annular body and being provided with a second combination portion, the bottom portion of the main body being provided with a first combination portion, the fastening member being detachably connected to the first combination portion of the main body through the second combination portion, the engaging feature of the lid abutting against an upper slot wall of the engaging slot, a limiting portion of the lid passing through the engaging slot, and the annular body abutting against the limiting portion.

28. A container assembly for beverages or food, adapted for a mobile device, comprising:
a body portion;
a lid, configured on the body portion, and comprising an engaging feature; and
a magnetic connecting attachment, comprising:
a main body, formed with an engaging slot, the main body being adapted to be arranged on the lid, and the engaging slot being adapted to be engaged with the engaging feature; and
a magnetic connecting member, pivotally or detachably connected to the main body, and being adapted to be magnetically connected to the mobile device.

29. The container assembly for beverages or food according to claim 28, wherein the main body defines a passage, and the main body is adapted to sleeve the lid through the passage.
